(19) United States
(12) Patent Application Publication
(10) Pub. No.: US 2010/0037870 A1
(43) Pub. Date: Feb. 18, 2010

(54) INTAKE MANIFOLD CONFIGURATION

(75) Inventors: Manuel ELZ, Vendersheim (DE); Ute SCHLEPPY, Rüsselsheim (DE); Arno NOE, Hanau (DE); Heiko PFERSDORF, Bodenheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/465,103

(22) Filed: May 13, 2009

(30) Foreign Application Priority Data
May 13, 2008 (DE) 102008023381.1

(51) Int. Cl. F02B 33/00; F02B 25/06; F02M 35/10

(52) U.S. Cl. 123/559.1; 123/574; 123/184.53

(57) ABSTRACT

An intake manifold configuration is provided for a chargeable internal combustion engine. The intake manifold configuration includes, but is not limited to an intake pipe leading to a turbocharger, an intake manifold leading from the turbocharger to the internal combustion engine, and a first blow-by channel leading from a crankcase of the internal combustion engine to the intake manifold, the first blow-by channel being connected via a valve to the intake manifold, and the intake manifold configuration comprising a second blow-by channel, which runs from the first blow-by channel to the intake pipe. In this way, on the one hand, a more compact construction of the internal combustion engine is made possible and, on the other hand, the susceptibility to frost is minimized and thus sufficient crankcase ventilation is ensured.

### CROSS-REFERENCE TO RELATED APPLICATION

This application claims priority to German Patent Application No. 102008023381.1, filed May 13, 2008, which is incorporated herein by reference in its entirety.

### TECHNICAL FIELD

The invention relates to an intake manifold configuration for a chargeable internal combustion engine.

### BACKGROUND

It is known that a part of the crankcase gases, the so-called blow-by gases, may also be combusted in an internal combustion engine. These gases are suctioned off and supplied to the intake manifold.

In charged internal combustion engines, recirculation of this type is not possible, because a counter pressure builds up in the intake manifold in charger operation and the blow-by gases would be pressed back into the crankcase via the blow-by channel.

In view of the foregoing, it is at least one object of the present invention to provide an intake manifold configuration which allows a sufficient crankcase ventilation of a charged internal combustion engine and a more compact construction of the internal combustion engine. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics are achieved according to an embodiment comprises an intake pipe leading to a turbocharger, an intake manifold leading from the turbocharger to the internal combustion engine, and a first blow-by channel leading from a crankcase of the internal combustion engine to the intake manifold. The first blow-by channel is connected via a valve to the intake manifold. Furthermore, the intake manifold configuration has a second blow-by channel, which runs from the first blow-by channel to the intake pipe.

In this way, sufficient ventilation of the crankcase is ensured in the charged operation of the internal combustion engine, if the internal combustion engine is in load operation. Furthermore, fewer components are used for the blow-by channel recirculation, whereby potential leaks inside the intake manifold configuration are minimized and a more compact engine construction is made possible. Due to the compact construction, fewer points result at which condensed water may precipitate, whereby the danger of icing in cold weather is reduced.

The valve is advantageously situated essentially inside the intake manifold, whereby the possibility of freezing of the crankcase ventilation in winter months is reduced. Separate heating of the individual lines, and/or introduction points and/or the throttle valve is thus no longer necessary. Through an internal placement of the valve, it is possible to produce the intake manifold together with the valve in one module, so that components may be saved, whereby the installation and/or uninstallation of the components is made easier, the space in the engine compartment is optimized, and costs are reduced. Furthermore, the susceptibility to frost of the crankcase ventilation is minimized in this way.

In particular, the second blow-by channel is situated adjacent to the intake manifold. Thus, on the one hand, space may be saved in the engine compartment and possibly occurring defective installations and/or potential leaks may be reduced.

The valve is preferably a check valve, which particularly closes automatically if the internal combustion engine is in load operation and an overpressure prevails in the intake manifold. Because of the closed check valve, the blow-by gases will first flow from the first blow-by channel via the second blow-by channel to the intake pipe, be compressed in the turbocharger, then be discharged to the intake manifold and supplied to the internal combustion engine.

It is especially advantageous if the second blow-by channel is a continuous channel. In this context, continuous means, for example, that no additional valve is provided inside the second blow-by channel, so that in load operation, the blow-by gases are suctioned out of the first blow-by channel by the partial vacuum in the intake pipe and may reach the intake pipe unobstructed via the second continuous blow-by channel. Optionally, a further valve, in particular a check valve, maybe provided solely at the transition of the second blow-by channel to the intake pipe before the turbocharger, in order to avoid a short-circuit flow via the second blow-by channel to the internal combustion engine past the turbocharger, whereby sufficient partial vacuum for suctioning out the blow-by gases may be ensured.

With the aid of a closed valve during the load operation it is possible that the blow-by gases, because of the partial vacuum in the intake manifold, are suctioned out of the first blow-by channel and flow via the second blow-by channel into the intake pipe. The blow-by gases, which have a lower density than the already compressed mixture in the intake manifold, are prevented from reaching the intake manifold by both the closed valve and also the partial vacuum in the intake pipe.

The valve is preferably open during normal operation, (i.e., in non-charged operation), so that it is ensured that in normal operation, when the pressure in the intake manifold is lower than the pressure in the intake pipe and in the crankcase, the blow-by gases flow from the first blow-by channel through the open valve into the intake manifold.

Furthermore, an internal combustion engine is provided for a motor vehicle having a crankcase and an intake manifold configuration, which is connected to the crankcase, and which may be implemented and refined as described above, whereby sufficient crankcase ventilation of a charged internal combustion engine and more compact construction of the internal combustion engine are ensured.

### BRIEF DESCRIPTION OF THE DRAWINGS

The present invention will hereinafter be described in conjunction with the following drawing figures, wherein like numerals denote like elements, and:

FIG. 1 shows a schematic conceptual illustration of an intake manifold configuration according to an embodiment of the invention; and

FIG. 2 shows a schematic side view of the intake manifold configuration according to an embodiment of the invention for a chargeable internal combustion engine in load operation.

### DETAILED DESCRIPTION

The following detailed description is merely exemplary in nature and is not intended to limit application and uses. Furthermore, there is no intention to be bound by any theory presented in the preceding background or summary or the following detailed description.

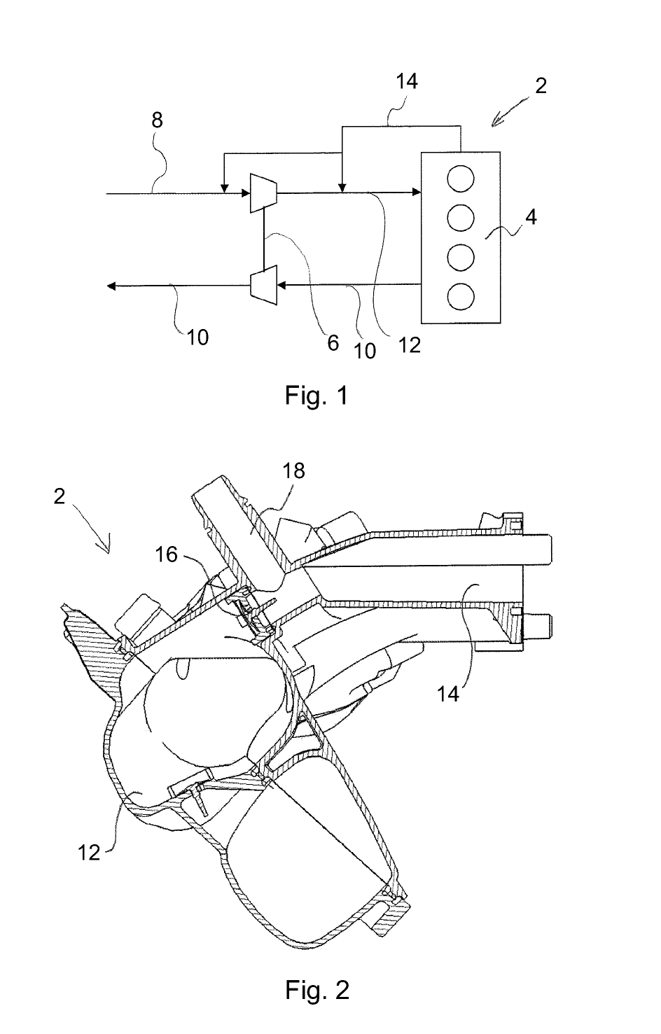

FIG. 1 shows an intake manifold configuration 2 having an internal combustion engine 4, which is connected to a turbocharger 6. On the intake side of the internal combustion engine 4, an intake pipe 8 first leads from an inlet (not shown) to the turbocharger 6, from which an intake manifold 12 leads to the internal combustion engine 4. An outlet pipe 10 leads from the internal combustion engine 4 via the turbocharger 6 to an outlet (not shown). Furthermore, a first blow-by channel 14 leads from a crankcase (not shown) of the internal combustion engine 4 to the intake manifold 12, in order to combust blow-by gases from the crankcase in the internal combustion engine 4. Furthermore, a second blow-by channel 18 leads from the first blow-by channel 14 to the intake pipe 8, in order to admix the blow-by gases with the suctioned-in fresh air shortly before the turbocharger 6 if necessary.

FIG. 2 illustrates an example of the intake manifold configuration 2 according to an embodiment of the invention for a internal combustion engine 4, an specifically to a chargeable internal combustion engine. The first blow-by channel 14 is connected via a check valve 16 to the intake manifold 12. In the load operation shown, the check valve 16 is closed, because an overpressure is present in the intake manifold 12. The check valve 16 is situated inside the intake manifold 12. Because of the load operation shown, the pressure in the intake pipe 8 is less than the pressure in the intake manifold 12, so that blow-by gases suctioned out of the crankcase first flow via the first blow-by channel 14, past the closed check valve 16, via the second blow-by channel 18 to the intake pipe 8. Subsequently, the blow-by gas is compressed in the turbocharger 6 and supplied via the intake manifold 12 to the internal combustion engine 4.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An intake manifold configuration for a internal combustion engine, comprising:
an intake pipe leading to a turbocharger;
an intake manifold leading from the turbocharger to the internal combustion engine; and
a first blow-by channel leading from an crankcase of the internal combustion engine to the intake manifold,
wherein the first blow-by channel is connected via a valve to the intake manifold, and the intake manifold configuration comprises a second blow-by channel that runs from the first blow-by channel to the intake pipe.

2. The intake manifold configuration according to claim 1, wherein the valve is situated essentially inside the intake manifold.

3. The intake manifold configuration according to claim 1, wherein the second blow-by channel is directly adjacent to the intake manifold.

4. The intake manifold configuration according to claim 1, wherein the valve is a check valve.

5. The intake manifold configuration according to claim 1, wherein the second blow-by channel is a continuous channel.

6. The intake manifold configuration according to claim 1, wherein the valve is a closed in load operation of the internal combustion engine.

7. The intake manifold configuration according to claim 1, wherein the valve is open in normal operation of the internal combustion engine.

8. An internal combustion engine for a motor vehicle, comprising:
a crankcase;
an intake manifold configuration that is connected to the crankcase.
an intake pipe leading to a turbocharger;
an intake manifold leading from the turbocharger to the internal combustion engine; and
a first blow-by channel leading from the crankcase of the internal combustion engine to the intake manifold;
wherein the first blow-by channel is connected via a valve to the intake manifold, and the intake manifold configuration comprises a second blow-by channel that runs from the first blow-by channel to the intake pipe.

9. The internal combustion engine according to claim 8, wherein the valve is situated essentially inside the intake manifold.

10. The internal combustion engine according to claim 8, wherein the second blow-by channel is directly adjacent to the intake manifold.

11. The internal combustion engine according to claim 8, wherein the valve is a check valve.

12. The internal combustion engine according to claim 8, wherein the second blow-by channel is a continuous channel.

13. The internal combustion engine according to claim 8, wherein the valve is a closed in load operation of the internal combustion engine.

14. The internal combustion engine according to claim 8, wherein the valve is open in normal operation of the internal combustion engine.
